(19) United States
(12) Patent Application Publication
(10) Pub. No.: US 2025/0050741 A1
(43) Pub. Date: Feb. 13, 2025

(54) VEHICLE BRAKING CONTROL APPARATUS

(71) Applicant: TOYOTA JIDOSHA KABUSHIKI KAISHA, Toyota-shi (JP)

(72) Inventor: Shigenori SHIBATA, Toyota-shi (JP)

(21) Appl. No.: 18/751,435

(22) Filed: Jun. 24, 2024

(30) Foreign Application Priority Data
Aug. 9, 2023 (JP) 2023-130039

(51) Int. Cl. B60L 7/18

(52) U.S. Cl. CPC B60L 7/18; B60L 2240/647

(57) ABSTRACT

A vehicle braking control apparatus comprising a regenerative braking device and a friction braking device, includes a road surface detector configured to detect a road surface condition in front of a vehicle, and a controller configured to execute cooperative control between the regenerative braking device and the friction braking device so as to generate a target braking force. The controller executes determining whether the road surface condition is in a predetermined condition in which the stability of the vehicle in braking is maintained or not, and in a state in which the road surface condition is in the predetermined condition and the target braking force is greater than the regenerative braking force generated by the regenerative braking device, generating the friction braking force by using the friction braking device of both a front wheel and a rear wheel so as to generate the target braking force.

### REFERENCE TO RELATED APPLICATIONS

This application claims priority from Japanese Patent Application No. 2023-130039 filed on Aug. 9, 2023. The entire content of the priority application is incorporated herein by reference.

### TECHNICAL FIELD

The present disclosure relates to a vehicle braking control apparatus.

### BACKGROUND ART

Conventionally, for example, there have been known a vehicle braking control apparatus disclosed in Japanese Unexamined Patent Application Publication No. 2021-130367. The conventional vehicle braking control apparatus is applied to a vehicle including a regenerative braking device and a friction braking device that generate braking force on each of a pair of left and right front wheels and each of a pair of left and right rear wheels. Then, when a deceleration request is made to the vehicle and it is determined that contact as braking-in for bringing a friction material of the friction braking device into contact with a rotating member such as a rotor is necessary, the conventional vehicle braking control apparatus operates the friction braking device before the regenerative braking device. As a result, the conventional vehicle braking control apparatus brings the friction material into contact with the rotating member of the friction braking device so as to achieve early recovery of the effectiveness of the friction braking device.

### SUMMARY

In the conventional vehicle braking control apparatus, the friction braking device is preferentially operated to bring the friction material into contact with the rotating member when the vehicle is new or when the vehicle travels a predetermined distance after the friction material is replaced, and friction braking force is generated by bringing the friction material into contact with the rotating member. Therefore, while the vehicle travels the predetermined distance, the friction braking device is frequently operated, and a load that generates frictional heat, wear, and the like is applied to the friction material of the friction braking device. Accordingly, while the friction material is frequently brought into contact with the rotating member, deterioration of the friction material in accordance with a decrease in the frequency of use of the friction material, for example, deterioration of the friction material due to water absorption is suppressed. However, after the vehicle travels the predetermined distance, in other words, after the contact of the friction material with the rotating member is completed, regenerative braking force by the regenerative braking device is preferentially applied, so that the frequency of operating the friction braking device is reduced. As a result, the load is not applied to the friction material, and there is a possibility that deterioration of the friction material may occur or progress.

Further, while the vehicle travels the predetermined distance, the friction braking force by the friction braking device is preferentially applied, in other words, the frequency of operating the regenerative braking device is reduced. Therefore, while the vehicle travels the predetermined distance, the amount of current recovered by regeneration of the regenerative braking device, that is, the amount of regenerative energy decreases. This affects possible driving distance of the vehicle using the regenerative energy (current), and thus so-called electric power consumption rate of the vehicle is affected. That is, in the conventional vehicle braking control apparatus, in a situation in which the friction material is brought into contact with the rotating member of the friction braking device, deterioration of the friction material is suppressed, but the electric power consumption rate is affected.

An object of the present disclosure is to provide a vehicle braking control apparatus capable of suppressing deterioration of a friction material of a friction braking device while ensuring regenerative energy.

An aspect of the present disclosure relates to a vehicle braking control apparatus, applied for a vehicle comprising a regenerative braking device configured to apply a regenerative braking force to a front wheel, a rear wheel or the front wheel and the rear wheel and a friction braking device configured to apply a friction braking force to the front wheel and the rear wheel, comprising a road surface detector configured to detect a road surface condition in front of the vehicle in a forward direction of the vehicle, and a controller configured to execute cooperative control between the regenerative braking device and the friction braking device so as to generate a target braking force for braking the vehicle.

The controller is configured to execute determining whether the road surface condition detected by the road surface detector is in a predetermined condition in which the stability of the vehicle in braking is maintained or not, and in a state in which the road surface condition is in the predetermined condition and the target braking force is greater than the regenerative braking force generated by the regenerative braking device, generating the friction braking force by using the friction braking device of both the front wheel and the rear wheel so as to generate the target braking force for braking the vehicle.

According to the present disclosure, the controller operates the friction braking devices provided on each of the front wheels and the rear wheels of the vehicle when generating the target braking force larger than the regenerative braking force. Thus, it is possible to generate the friction braking force. Therefore, in the vehicle, it is possible to increase the frequency of operation of the friction braking device while the regenerative energy is recovered by the regenerative braking device. As a result, it is possible to apply an appropriate load to the friction material of the friction braking devices provided on each of the front wheels and the rear wheels. Therefore, in the friction material to which the load is applied, it is possible to suppress deterioration due to a decrease in frequency of use.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a schematic configuration diagram of a vehicle and a vehicle braking control apparatus according to the present embodiment;

FIG. 2 is a graph for explaining friction braking force when regenerative braking force is increased;

FIG. 3 is a flowchart of a braking control program;

FIG. 4 is a graph for explaining the regenerative braking force in the rear wheel side and the friction braking forces in the rear wheel side and the front wheel side according to the embodiment;

FIG. 5 is a graph for explaining the regenerative braking force in the rear wheel side and the friction braking forces in the rear wheel side and the front wheel side with replacement according to the first modification; and

FIG. 6 is a graph for explaining the regenerative braking force in the front wheel side and the friction braking forces in the front wheel side and the rear wheel side with replacement according to the second modification.

### DESCRIPTION

Hereinafter, there will be described a vehicle braking control apparatus according to an embodiment of the present disclosure in detail with reference to the drawings. In addition to the embodiments described below, the present disclosure can be implemented in various forms with various modifications and improvements based on the knowledge of those skilled in the art.

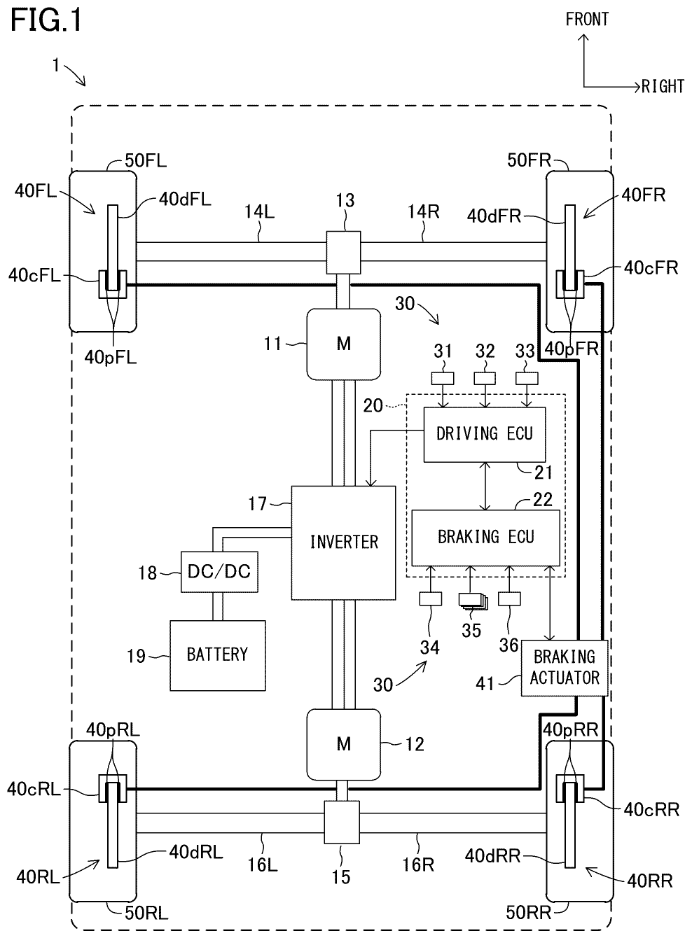

As shown in FIG. 1, a vehicle 1 to which the vehicle braking control apparatus of the present embodiment is applied includes a front motor 11 that drives a left front wheel 50FL and a right front wheel 50FR, and a rear motor 12 that drives a left rear wheel 50RL and a right rear wheel 50RR. Hereinafter, the left front wheel 50FL and the right front wheel 50FR may be collectively referred to as “front wheels 50F”, and the left rear wheel 50RL and the right rear wheel 50RR may be collectively referred to as “rear wheels 50R”. When it is not necessary to distinguish between the front wheels 50F and the rear wheels 50R, the front wheels 50F and the rear wheels 50R may be simply referred to as “wheels 50”. Note that the vehicle 1 is a general front-wheel steering type vehicle in which the front wheels 50F are steered wheels, but illustration and description of a steering mechanism thereof are omitted.

In the vehicle 1, rotation of an output shaft of the front motor 11 is transmitted to left and right front wheel axles 14L and 14R via a differential gear 13 (including a reduction gear). As a result, in the vehicle 1, the left front wheel 50FL and the right front wheel 50FR are rotationally driven. In the vehicle 1, rotation of the output shaft of the rear motor 12 is transmitted to left and right rear wheel axles 16L and 16R via a differential gear 15 (including a reduction gear). As a result, in the vehicle 1, the left rear wheel 50RL and the right rear wheel 50RR are rotationally driven. That is, the vehicle 1 is a four-wheel drive electric vehicle.

Each of the front motor 11 and the rear motor 12 is configured to be able to independently drive forward rotation in a forward direction of the vehicle 1 and reverse rotation in a backward direction of the vehicle 1 by energization control of the inverter 17. In the vehicle 1 of the present embodiment, the inverter 17 has a function of converting an alternating current generated by the rear motor 12 into a direct current and storing regenerative energy for charging the battery 19 via a DC/DC converter 18.

Thus, in the vehicle 1 of the present embodiment, the rear motor 12 generates braking torque and applies regenerative braking force to the rear wheels 50R. That is, in the present embodiment, the rear motor 12 has a function of a motor generator. In the vehicle 1 of the present embodiment, the front motor 11 does not have a function of regenerating electric power in the battery 19 unlike the rear motor 12, and the front motor 11 cannot apply regenerative braking force to the front wheels 50F.

The operation of each of the front motor 11 and the rear motor 12 is controlled by a drive ECU 21 constituting the controller 20. The drive ECU 21 is an electronic control unit including a microcomputer as a main part. The microcomputer includes a CPU and storage devices such as a ROM and a RAM, and the CPU achieves various functions by executing programs (instructions) stored in the ROM.

A detection signal of an accelerator sensor 31 that detects an accelerator operation amount is input to the drive ECU 21 from a sensor group 30, and the drive ECU 21 calculates driver request driving force corresponding to the accelerator operation amount. Then, the drive ECU 21 calculates front wheel target driving force and rear wheel target driving force respectively distributed to the front wheels 50F side and the rear wheels 50R side from the calculated driver request driving force, and the drive ECU 21 controls the front motor 11 and the rear motor 12 such that the front wheel target driving force and the rear wheel target driving force are transmitted to the front wheels 50F and the rear wheels 50R, respectively. For example, a detection signal output from a control sensor 32 of the front motor 11 is input to the drive ECU 21, and the drive ECU 21 controls the operation of the inverter 17 to control energization of the front motor 11. Similarly, a detection signal output from a control sensor 33 of the rear motor 12 is input to the drive ECU 21, and the drive ECU 21 controls the operation of the inverter 17 to control energization of the rear motor 12.

The vehicle 1 includes a brake ECU 22 that constitutes the controller 20. The vehicle 1 includes friction brake mechanisms 40FL, 40FR, 40RL, and 40RR (hereinafter, simply referred to as “friction brake mechanisms 40”) respectively provided in the left front wheel 50FL, the right front wheel 50FR, the left rear wheel 50RL, and the right rear wheel 50RR, and an brake actuator 41 electrically connected to the brake ECU 22.

The friction brake mechanism 40 includes brake discs 40dFL, 40dFR, 40dRL, and 40dRR (hereinafter simply referred to as “brake discs 40d”) respectively fixed to the wheels 50, and brake calipers 40cFL, 40cFR, 40cRL, and 40cRR (hereinafter simply referred to as “brake calipers 40c”) each fixed to the vehicle body. The friction brake mechanism 40 actuates a wheel cylinder (not shown) built in the brake caliper 40c by hydraulic pressure of hydraulic oil supplied from the brake actuator 41. Thus, the friction brake mechanism 40 includes brake pads 40pFL, 40pFR, 40pRL, and 40pRR (hereinafter, simply referred to as “brake pads 40p”) as friction materials. Thus, frictional braking force is generated when the brake pads 40p is pushed onto the brake discs 40d.

The brake actuator 41 is provided between the friction brake mechanism 40 and a master cylinder (not shown) that pressurizes hydraulic oil by stepping force of a brake pedal (not shown). The brake actuator 41 is an actuator that controls the hydraulic pressure of the brake hydraulic oil supplied to a wheel cylinder (not shown) incorporated in each of the brake calipers 40c. Here, for example, the brake actuator 41 can apply the friction braking force to the wheels 50 by independently controlling the hydraulic pressure of the wheel cylinder (not illustrated) on each of the front wheels 50F side and the rear wheels 50R side. The brake actuator 41 can also apply the friction braking force to the wheels 50 by independently controlling the hydraulic pressure of the wheel cylinder (not shown) in each of the four wheels.

The brake actuator 41 is electrically connected to the brake ECU 22, and the operation of the brake actuator 41 is controlled by the brake ECU 22. The brake ECU 22 is an electronic control unit including a microcomputer as a main part. The brake ECU 22 is connected to the drive ECU 21 via a controller area network (CAN) (not shown) so as to be capable of mutual transmission and reception.

Hydraulic pressure sensors, various control valves, and pumps (not shown) provided in the brake actuator 41 are connected to the brake ECU 22. A brake sensor 34 and four wheel speed sensors 35 of the sensor group 30 are connected to the brake ECU 22. The brake sensor 34 detects a brake operation amount of a driver from a stepping amount (or an angle, a pressure, or the like) of a brake pedal (not shown).

A road surface condition detection sensor 36 of the sensor group 30 is connected to the brake ECU 22. The road surface condition detection sensor 36 includes, for example, a stereo camera or a LiDAR, and detects a condition of road surface in front of the vehicle 1 in a forward direction. Here, the road surface condition detection sensor 36 can detect, as a condition of the road surface, a condition in which there is a possibility of causing decrease in the braking force, specifically, a condition in which a friction coefficient μ of the road surface decreases, such as wetting (puddle) of the road surface due to rainfall or snow accumulation or freezing of the road surface due to snowfall. In other words, the road surface condition detection sensor 36 can detect a dry road surface in which the friction coefficient μ of the road surface is high as the condition of the road surface.

The brake ECU 22 executes a process of calculating friction braking force (corresponding to hydraulic braking force) generated in the friction brake mechanism 40 and regenerative braking force generated in the rear motor 12 such that target braking force Vtb required by the brake pedal operation is achieved. Further, the brake ECU 22 executes a process of transmitting information (regenerative brake command) indicating the calculated (or determined) regenerative braking force to the drive ECU 21. The brake ECU 22 executes a process of controlling the operation of the brake actuator 41 based on the friction braking force (hydraulic braking force). Further, the brake ECU 22 calculates a vehicle speed (vehicle body speed) based on wheel speeds of the four wheels detected by the wheel speed sensors 35, and the brake ECU 22 also executes a process of transmitting vehicle speed information indicating the calculated vehicle speed to a plurality of vehicle-mounted ECUs including the drive ECU 21 via a communication network (not shown).

In a case where the regenerative brake command transmitted from the brake ECU 22 is input to the drive ECU 21, the drive ECU 21 outputs, to the inverter 17, a control signal generated such that the regenerative braking force required as information included in the regenerative brake command is applied to the rear wheels 50R. Thus, the duty ratio of the switching elements of the inverter 17 is controlled. As a result, a current corresponding to the regenerative braking force flows from the rear motor 12 to the battery 19 via the DC/DC converter 18, that is, regenerative energy is recovered, and braking force is applied to the rear wheels 50R.

A configuration including the friction brake mechanism 40, the brake actuator 41, the brake pedal (not shown), and the master cylinder (not shown) corresponds to a friction braking device of the present disclosure. A configuration including the rear motor 12 (or the front motor 11 described later), the inverter 17, the DC/DC converter 18, and the battery 19 corresponds to a regenerative braking device of the present disclosure. The controller 20 including the drive ECU 21 and the brake ECU 22 executes cooperative control of the regenerative braking device and the friction braking device. Further, the wheel speed sensor 35 and the road surface condition detection sensor 36 correspond to a road surface condition detector of the present disclosure.

Next, there will be described the braking control of the present embodiment. In a case where the regenerative braking force is applied only to the rear wheels 50R by the rear motor 12, a current generated by the rear motor 12 functioning as a generator is charged into the battery 19 via the DC/DC converter 18 and recovered. Then, the recovered current, that is, regenerative energy is supplied to the front motor 11 and the rear motor 12, for example, during traveling of the vehicle 1, whereby the front wheels 50F and the rear wheels 50R are driven by the regenerative energy. Therefore, the more efficiently and largely the regenerative energy is recovered, the longer the distance that can be traveled by driving the front wheels 50F and the rear wheels 50R becomes. That is, it is possible to improve the electric power consumption rate.

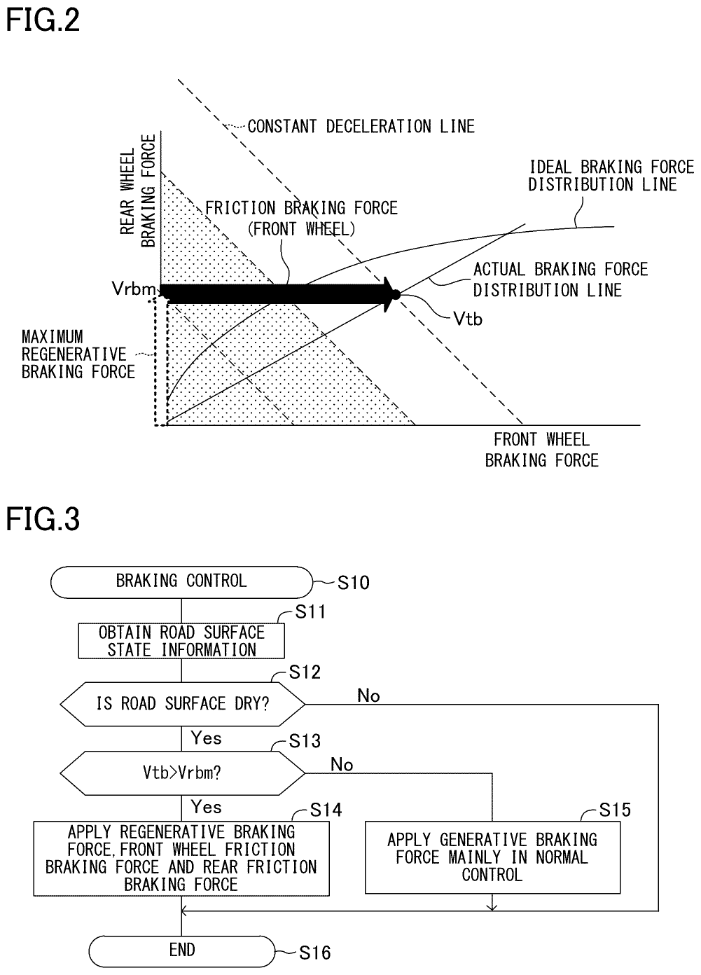

Therefore, in the vehicle 1, in a case where the regenerative braking force is generated only in the rear wheels 50R, the brake ECU 22 outputs the regenerative brake command indicating the regenerative braking force to the drive ECU 21 so that the maximum regenerable energy can be recovered during braking. Specifically, as shown in FIG. 2, the brake ECU 22 sets, as the regenerative braking force of the rear wheels 50R, the maximum regenerable braking force Vrbm determined on the basis of the maximum recoverable regenerative energy during braking of the vehicle 1, and the brake ECU 22 outputs the regenerative brake command including the maximum regenerable braking force Vrbm.

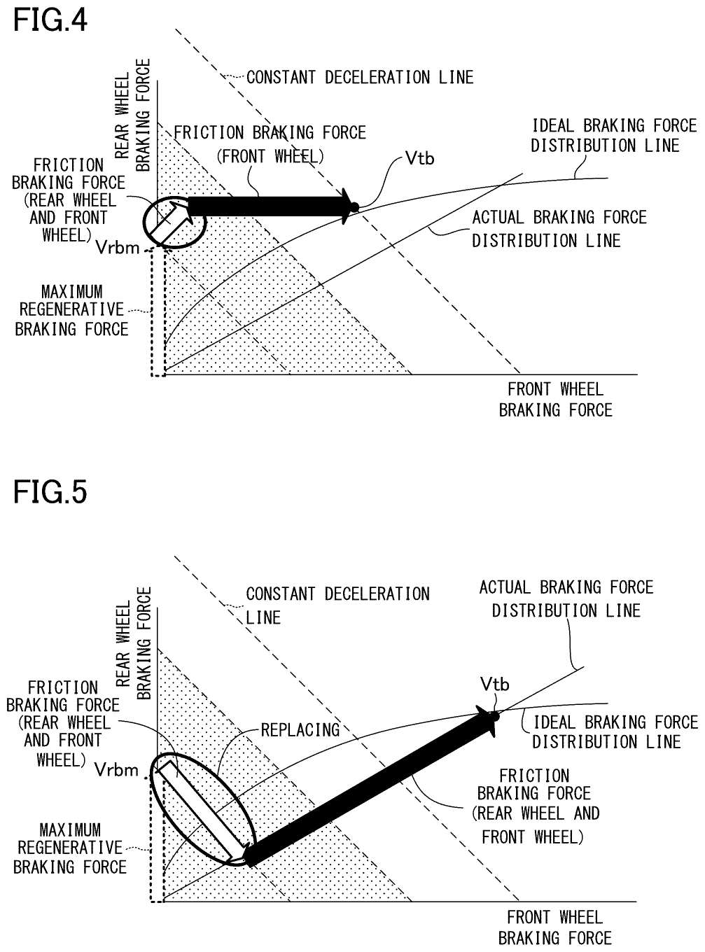

Then, the brake ECU 22 sets, as the friction braking force of the front wheels 50F, the braking force that covers insufficient braking force when the drive ECU 21 applies the maximum regenerable braking force Vrbm to the rear wheels 50R, based on the target braking force Vtb (indicated by a black circle in FIG. 2) required for the vehicle 1 by the driver, and the brake ECU 22 operates the friction brake mechanism 40 of the front wheels 50F to generate the braking force that matches the target braking force Vtb in the vehicle 1. In FIG. 2 and FIGS. 4, 5, and 6 to be described later, a region indicated by dots represents a normal braking region of the vehicle 1.

As described above, in a case where the regenerative braking force of the rear wheels 50R is set to the maximum regenerable braking force Vrbm so that more regenerative energy can be recovered, that is, the electric power consumption rate can be further improved, as shown in FIG. 2, only the friction brake mechanism 40 of the front wheels 50F operates without following an actual braking force distribution line, and the friction braking force is applied to the front wheels 50F. That is, in the vehicle 1 in which the regenerative braking force is applied only to the rear wheels 50R, in the case where the maximum regenerable braking force Vrbm is set to be applied to the rear wheels 50R, the frequency of operation of the friction brake mechanism 40 of the rear wheels 50R is extremely reduced.

Therefore, the brake pads 40pRL and 40pRR constituting the friction brake mechanism 40 of the rear wheels 50R are less frequently pressed against and brought into contact with the brake discs 40dRL and 40dRR. As a result, the frequency of a load, that is applied to the brake pads 40pRL and 40pRR and that causes generation of frictional heat, surface wear, and the like decreases. As a result, for example, as the use frequency of the brake pads 40pRL and 40pRR decreases, the brake pads 40pRL and 40pRR may deteriorate due to water absorption into the brake pads 40pRL and 40pRR, or the deterioration may progress.

Therefore, in the present embodiment, the brake ECU 22 executes the braking control program shown in FIG. 3 every time a predetermined short time elapses. In the present embodiment, the brake ECU 22 executes the braking control program, whereby the friction brake mechanism 40 for the rear wheels 50R is actively operated without affecting the electric power consumption rate, in other words, without reducing the regenerative energy that can be recovered by the rear motor 12. As a result, in the present embodiment, the operation frequency of the friction brake mechanism 40 for the rear wheels 50R is increased, and the load is applied to the brake pads 40pRL and 40pRR. As a result, deterioration of the brake pad 40p is suppressed. Hereinafter, there will be described the braking control program specifically.

In step S10, the brake ECU 22 (more specifically, the CPU of the microcomputer constituting the brake ECU 22) starts execution of the braking control program. In subsequent step S11, the brake ECU 22 obtains road surface condition information such as an image indicating the road surface condition detected by the road surface condition detection sensor 36 and/or wheel speed information detected by the wheel speed sensor 35 of each of the wheels 50.

In subsequent step S12, the brake ECU 22 determines whether or not the road surface condition is a predetermined condition in which stability is maintained in braking of the vehicle 1, specifically, whether or not the road surface condition is a dry road surface having a high friction coefficient μ, based on the obtained road surface information and/or wheel speed information. That is, as described later, the brake ECU 22 determines whether or not the road surface is the dry road surface so as to prevent the stability of the vehicle 1 from being decreased even when the vehicle 1 is braked. Therefore, when the road surface is the dry road surface, the brake ECU 22 makes a “Yes” determination, and executes the processing of step S13 and subsequent steps. On the other hand, when the road surface is not the dry road surface, for example, when the road surface is a wet road surface having a low friction coefficient μ due to rainfall, snow accumulation, or the like, the brake ECU 22 makes a “No” determination, and ends the execution of the program in step S16.

In step S13, the brake ECU 22 determines whether or not the target braking force Vtb requested by the driver is larger than the maximum regenerable braking force Vrbm generated by the rear motor 12 of the rear wheels 50R. That is, when the target braking force Vtb is larger than the maximum regenerable braking force Vrbm, the brake ECU 22 determines “Yes” and executes the process of step S14.

In step S14, the brake ECU 22 cooperates with the drive ECU 21 to cause the rear motor 12 to generate the maximum regenerable braking force Vrbm as the regenerative braking force. That is, the rear motor 12 generates the maximum regenerable braking force Vrbm as the rear wheel braking force in the rear wheels 50R as indicated by a broken line white arrow in FIG. 4. As a result, the rear motor 12 can recover a current corresponding to the maximum regenerable braking force Vrbm, that is, the regenerative energy as much as possible as the generator.

On the other hand, the brake ECU 22 sets braking force corresponding to a difference between the target braking force Vtb and the maximum regenerable braking force Vrbm as the friction braking force. Then, the brake ECU 22 operates the friction brake mechanism 40 for the front wheels 50F and the friction brake mechanism 40 for the rear wheels 50R to generate the set friction braking force. Specifically, the brake ECU 22 operates the friction brake mechanisms 40 for the front wheels 50F and the rear wheels 50R as indicated by a solid line white arrow encircled by a bold circle in FIG. 4. As a result, in the friction brake mechanism 40 of the rear wheels 50R, the brake pads 40pRL and 40pRR are pressed against the brake discs 40dRL and 40dRR to apply the friction braking force. Subsequently, the brake ECU 22 stops the operation of the friction brake mechanism 40 of the rear wheels 50R, that is, operates only the friction brake mechanism 40 of the front wheels 50F, and finally generates the target braking force Vtb set on the constant deceleration line in the vehicle 1. Thus, the vehicle 1 can be stopped.

Here, the friction braking force applied by the friction brake mechanism 40 of the rear wheels 50R is smaller than the friction braking force applied by the friction brake mechanism 40 of the front wheels 50F. This is to prevent the stability of the vehicle 1 from being decreased even when the friction braking force is further applied to the rear wheels 50R to which the rear motor 12 applies the maximum regenerable braking force Vrbm as described above. Therefore, the brake ECU 22 controls the operation of the friction brake mechanism 40 of the rear wheels 50R via the brake actuator 41 so that appropriate braking force is generated in the rear wheels 50R, for example, based on the wheel speed information detected by the wheel speed sensor 35.

Returning to the flowchart of FIG. 3 again, the brake ECU 22 executes the process of step S16 after stopping the vehicle 1 in step S14. In step S16, the brake ECU 22 temporarily ends the execution of the braking control program. Then, the brake ECU 22 starts the execution of the braking control program again in step S10 after the predetermined short time has elapsed.

On the other hand, in step S13, in a case where the target braking force Vtb is equal to or smaller than the maximum regenerable braking force Vrbm, for example, in a case where the target braking force Vtb is within the normal braking range indicated by the dots in FIG. 4, the brake ECU 22 makes a “No” determination, and executes the process of step S15. In step S15, the brake ECU 22 cooperates with the drive ECU 21 to brake the vehicle 1 by the normal control for mainly generating the regenerative braking force.

That is, the brake ECU 22 outputs a regenerative brake command to the drive ECU 21 so as to generate, for example, regenerative braking force equal to the maximum regenerable braking force Vrbm in the rear wheels 50R according to the target braking force Vtb by the driver. Thus, the drive ECU 21 outputs a control signal for setting the maximum regenerable braking force Vrbm as the regenerative braking force to the inverter 17. As a result, the braking force of the maximum regenerable braking force Vrbm is applied to the rear wheels 50R, and the vehicle 1 is decelerated to an extremely slow speed. Then, the brake ECU 22 completely stops the vehicle 1 by, for example, operating the friction brake mechanism 40 of the front wheels 50F to generate the friction braking force in the front wheels 50F in a state in which the vehicle 1 is at an extremely slow speed.

After stopping the vehicle 1 in step S15, the brake ECU 22 executes the process of step S16. In step S16, the brake ECU 22 temporarily ends the execution of the braking control program. Then, the brake ECU 22 starts the execution of the braking control program again in step S10 after the predetermined short time has elapsed.

As can be understood from the above description, according to the vehicle braking control apparatus of the present embodiment, when generating the target braking force Vtb larger than the maximum regenerable braking force Vrbm, the brake ECU 22 constituting the controller 20 operates the friction brake mechanisms 40 constituting the friction braking devices provided in the front wheels 50F and the rear wheels 50R of the vehicle 1 to generate the friction braking force. As a result, the operation frequency of the friction brake mechanism 40 constituting the friction braking device can be increased. As a result, the appropriate load is applied to the brake pads 40p, which are the friction materials of the friction brake mechanisms 40 provided in the front wheels 50F and the rear wheels 50R, and, for example, frictional heat can be generated, and surface wear and the like can be caused. Therefore, it is possible to suppress deterioration due to a decrease in the frequency of use of the brake pad 40p to which the load is applied, specifically, it is possible to suppress deterioration due to water absorption.

Next, there will be described a first modification of the above-described embodiment. In the first modification, the braking control is executed in a case where the target braking force Vtb larger than the target braking force Vtb in the above embodiment is requested.

Specifically, as shown in FIG. 5, in the first modified example, the target braking force Vtb indicated by a black circle is required as a value larger than the target braking force Vtb of the above embodiment indicated by the black circle in FIG. 4. In this case, in step S14 in the braking control program shown in FIG. 3, the brake ECU 22 first generates the maximum regenerable braking force Vrbm by the rear motor 12 to brake the vehicle 1 while recovering the regenerative energy, as in the above embodiment.

In the first modification, in order to generate the larger target braking force Vtb, the brake ECU 22 cooperates with the drive ECU 21 to execute the braking control by causing the friction braking device and the regenerative braking device to cooperate with each other. That is, the brake ECU 22 and the drive ECU 21 replace the regenerative braking force with the friction braking force so as to decrease at least a part of the maximum regenerable braking force Vrbm applied by the rear motor 12, that is, the regenerative braking force, and increase the friction braking force applied by the friction brake mechanism 40 of the front wheels 50F and the friction brake mechanism 40 of the rear wheels 50R.

Specifically, the drive ECU 21 gradually decreases the regenerative braking force by the rear motor 12 from the maximum regenerable braking force Vrbm in accordance with the regenerative brake command by the brake ECU 22 as indicated a solid line white arrow encircled by a bold circle in FIG. 5. On the other hand, the brake ECU 22 operates the friction brake mechanism 40 for the front wheels 50F and the friction brake mechanism 40 for the rear wheels 50R via the brake actuator 41 in accordance with the decrease in the regenerative braking force by the rear motor 12.

As a result, the brake ECU 22 controls the friction brake mechanisms 40 for the front wheels 50F and the rear wheels 50R such that the braking force corresponding to an intersection point between the constant deceleration line and the actual braking force distribution line is generated in the vehicle 1 while increasing the friction braking force as indicated by the solid line white arrow in FIG. 5. Then, the brake ECU 22 operates the friction brake mechanisms 40 of the front wheels 50F and the rear wheels 50R via the brake actuator 41 so that the generated braking force follows the actual braking force distribution line, and generates the friction braking force in the front wheels 50F and the rear wheels 50R while securing the stability of the vehicle 1 until the generated braking force becomes the target braking force Vtb.

Thus, also in the first modification, the regenerative energy can be recovered and the frequency of operation of the friction brake mechanism 40 can be increased in the rear wheels 50R in which the regenerative braking force is generated by the rear motor 12. Therefore, also in the first modification, the load that causes generation of frictional heat, surface wear, and the like in the brake pads 40pRL and 40pRR constituting the brake mechanism 40 of the rear wheels 50R is applied to the brake pads 40pRL and 40pRR more frequently. As a result, also in the first modification, the regenerative energy can be recovered, and it is possible to suppress progress of deterioration of the brake pads 40pRL and 40pRR.

Next, there will be described a second modification of the above-described embodiment. In the second modification, the braking control is executed in a case where the regenerative braking force is generated only by the front motor 11 instead of the rear motor 12 of the vehicle 1.

In the second modification, in the vehicle 1, the front motor 11 generates the braking torque and applies the regenerative braking force to the front wheels 50F. That is, in the second modification, the front motor 11 functions as a motor generator. Therefore, in the second modified example, unlike the embodiment and the first modified example described above, the rear motor 12 does not have a function of performing power regeneration for the battery 19, and cannot apply regenerative braking force to the rear wheels 50R.

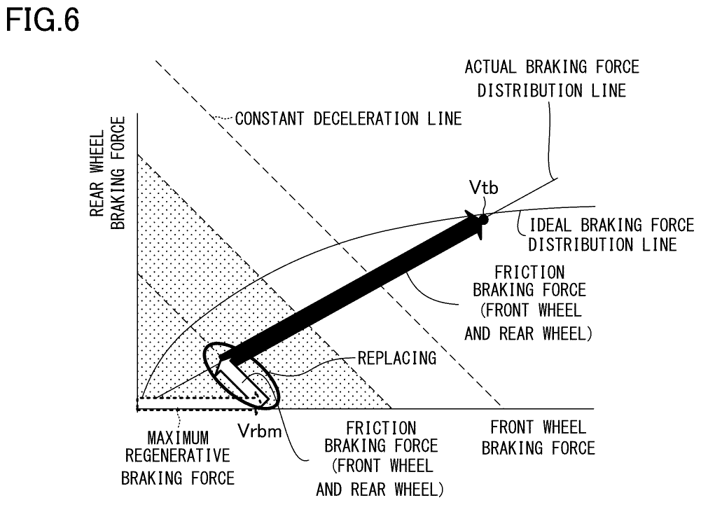

Also in the second modified example, as shown in FIG. 6, the target braking force Vtb indicated by a black circle in FIG. 6 is required as a value larger than the target braking force Vtb of the above embodiment indicated by the black circle in FIG. 4. In this case, in step S14 of the braking control program shown in FIG. 3, the brake ECU 22 first applies the maximum regenerable braking force Vrbm to the front wheels 50F by the front motor 11, thereby braking the vehicle 1 while recovering the regenerative energy.

In the second modification, in order to generate the larger target braking force Vtb, the brake ECU 22 cooperates with the drive ECU 21 to execute the braking control by causing the friction braking device and the regenerative braking device to cooperate with each other. That is, the brake ECU 22 and the drive ECU 21 replace the regenerative braking force with the friction braking force so as to decrease at least a part of the maximum regenerable braking force Vrbm applied by the front motor 11, that is, the regenerative braking force, and increase the friction braking force applied by the friction brake mechanism 40 of the front wheels 50F and the friction brake mechanism 40 of the rear wheels 50R.

Specifically, the drive ECU 21 gradually reduces the regenerative braking force generated by the front motor 11 from the maximum regenerable braking force Vrbm in accordance with the regenerative brake command by the brake ECU 22, as indicated by a solid line white arrow encircled by a bold circle in FIG. 6. On the other hand, the brake ECU 22 operates the friction brake mechanism 40 for the front wheels 50F and the friction brake mechanism 40 for the rear wheels 50R via the brake actuator 41 in accordance with the decrease in the regenerative braking force by the front motor 11.

As a result, the brake ECU 22 controls the friction brake mechanisms 40 for the front wheels 50F and the rear wheels 50R such that the braking force corresponding to the intersection point between the constant deceleration line and the actual braking force distribution line is generated in the vehicle 1 while increasing the friction braking force as indicated by the solid line white arrow in FIG. 6. Then, the brake ECU 22 operates the friction brake mechanisms 40 of the front wheels 50F and the rear wheels 50R via the brake actuator 41 so that the generated braking force follows the actual braking force distribution line, and generates the friction braking force in the front wheels 50F and the rear wheels 50R while securing the stability of the vehicle 1 until the generated braking force reaches the target braking force Vtb.

As a result, in the second modified example, the regenerative energy can be recovered in the front wheels 50F in which the regenerative braking force is generated by the front motor 11. Further, in the second modified example, it is possible to increase the operation frequency at which the brake pads 40pFL and 40pFR constituting the friction brake mechanism 40 are pressed against and brought into contact with the brake discs 40dFL and 40dFR in the front wheels 50F. Therefore, the brake pads 40pFL and 40pFR constituting the brake mechanism 40 of the front wheels 50F have an opportunity to be operated in the extremely slow speed region by the normal control described above, for example, but a load that causes generation of larger frictional heat, surface wear, and the like is applied to the brake pads 40pFL and 40pFR more frequently. As a result, it is possible to suppress progress of the deterioration of the brake pads 40pFL, 40pFR.

The present disclosure is not limited to the above-described embodiment, the first modification, and the second modification, and various modifications can be made. For example, in the embodiment and the first modification, the case where the regenerative braking force is applied only by the rear motor 12 of the rear wheels 50R is exemplified, and in the second modification, the case where the regenerative braking force is applied only by the front motor 11 of the front wheels 50F is exemplified. However, the regenerative braking force may be applied by both the front motor 11 for the front wheels 50F and the rear motor 12 for the rear wheels 50R. Furthermore, the vehicle 1 is not limited to an electric vehicle (EV) in which only at least one of the front motor 11 and the rear motor 12 is mounted, and may be a hybrid vehicle (HEV, PHEV) in which an internal combustion engine is also mounted.

What is claimed is:

1. A vehicle braking control apparatus, applied for a vehicle comprising a regenerative braking device configured to apply a regenerative braking force to a front wheel, a rear wheel or the front wheel and the rear wheel and a friction braking device configured to apply a friction braking force to the front wheel and the rear wheel, comprising:
a road surface detector configured to detect a road surface condition in front of the vehicle in a forward direction of the vehicle; and
a controller configured to execute cooperative control between the regenerative braking device and the friction braking device so as to generate a target braking force for braking the vehicle,
wherein the controller is configured to execute:
determining whether the road surface condition detected by the road surface detector is in a predetermined condition in which a stability of the vehicle in braking is maintained or not; and
in a state in which the road surface condition is in the predetermined condition and the target braking force is greater than the regenerative braking force generated by the regenerative braking device, generating the friction braking force by using the friction braking device of both the front wheel and the rear wheel so as to generate the target braking force for braking the vehicle.

2. The vehicle braking control apparatus according to claim 1,
wherein the regenerative braking device is configured to apply the regenerative braking force to the rear wheel, and
wherein, in the state in which the road surface condition is in the predetermined condition and the target braking force is greater than the regenerative braking force generated by the regenerative braking device, the controller is configured to execute generating the friction braking force so that a friction braking force generated by the friction braking device of the rear wheel is smaller a friction braking force generated by the friction braking device of the front wheel.

3. The vehicle braking control apparatus according to claim 1,
wherein the regenerative braking device is configured to apply the regenerative braking force to the rear wheel, and
wherein, in the state in which the road surface condition is in the predetermined condition and the target braking force is greater than the regenerative braking force generated by the regenerative braking device, the controller is configured to execute replacing at least a part of the regenerative braking force applied to the rear wheel by the regenerative braking device with the friction braking force generated by both the friction braking device of the rear wheel and the friction braking device of the front wheel, and generating the friction braking force by using both the friction braking device of the rear wheel and the friction braking device of the front wheel so as to generate the target braking force for braking the vehicle.

4. The vehicle braking control apparatus according to claim 1,
wherein the regenerative braking device is configured to apply the regenerative braking force to the front wheel, and
wherein, in the state in which the road surface condition is in the predetermined condition and the target braking force is greater than the regenerative braking force generated by the regenerative braking device, the controller is configured to replacing at least a part of the regenerative braking force applied to the front wheel by the regenerative braking device with the friction braking force generated by both the friction braking device of the rear wheel and the friction braking device of the front wheel, and generating the friction braking force by using both the friction braking device of the rear wheel and the friction braking device of the front wheel so as to generate the target braking force for braking the vehicle.

5. The vehicle braking control apparatus according to claim 1,
wherein the regenerative braking force applied by the regenerative braking device is determined based on a maximum recoverable regenerative energy in braking.
